(19) United States
(12) Patent Application Publication
(10) Pub. No.: US 2009/0045185 A1
(43) Pub. Date: Feb. 19, 2009

(54) FOOD HOLDING OVEN WITH MATTE FINISH FOOD HOLDING TRAY

(76) Inventors: Jeff SCHROEDER, Lake Zurich, IL (US); Loren VELTROP, Chicago, IL (US)

Correspondence Address: LADAS & PARRY LLP, 224 SOUTH MICHIGAN AVENUE, SUITE 1600, CHICAGO, IL, 60604, US

(21) Appl. No.: 11/839,043

(22) Filed: Aug. 15, 2007

(51) Int. Cl. A21B 1/22; A21B 3/00

(52) U.S. Cl. 219/411; 219/392

(57) ABSTRACT

A food holding oven, which is used to keep previously-prepared foods hot until they are served, is provided with a food holding tray having a roughened or matte finish. The matte finish keeps the tray's service temperature lower and easier to handle than prior art trays with highly reflective, shiny surfaces. When the matte-finish tray is held under a principally pure infrared heat source for long periods of time, the tray's surface temperature prevents food from being burned and reduces the likelihood of a user being burned.

### BACKGROUND

This invention relates to food preparation equipment. More particularly this invention relates to an oven used to hold previously prepared foods at a relatively constant temperature until they are sold or served for consumption. Such ovens are often used in fast food restaurants to keep foods hot and ready for consumption.

### BRIEF DESCRIPTION OF THE DRAWINGS

FIG. 1 is a perspective view of a preferred embodiment of food holding oven 10, using incandescent heat lamps;

FIG. 2 is a cross-sectional view of the oven depicted in FIG. 1; and

FIG. 3 is a perspective view of another embodiment of a food holding oven using a planar source of infrared.

### DETAILED DESCRIPTION

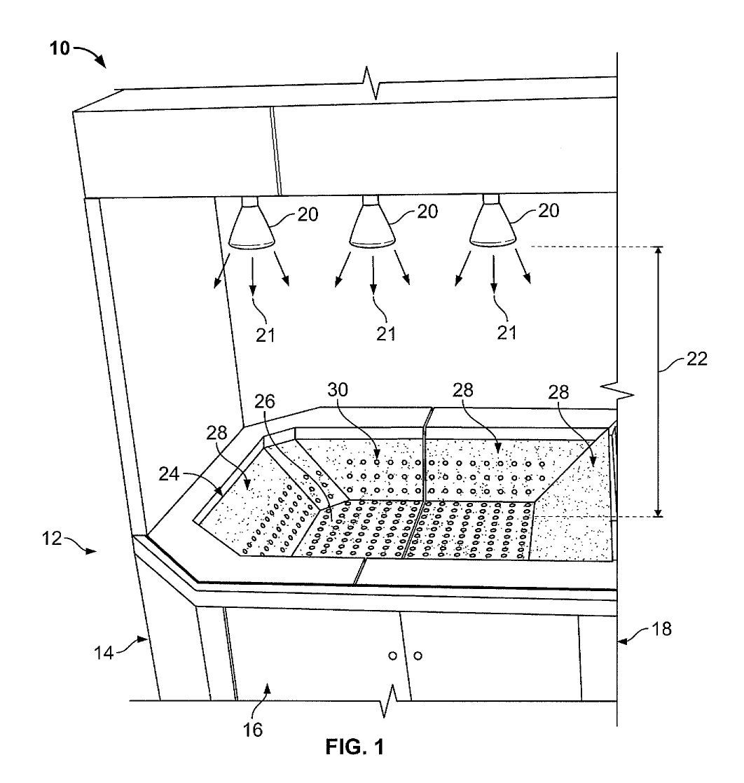

FIG. 1 is a perspective view of a food holding oven 10. The oven is comprised of a base cabinet 12 having four sides, three of which are shown and identified by reference numerals 14, 16 and 18.

The base cabinet 12 supports a food holding tray 24, preferably made from stainless steel. The food holding tray 24 has a bottom 26 and several inclined sides 28, the arrangement of which gives the food holding tray the shape of an inverted frusto-pyramid having an open or missing base, which faces upwardly toward an infrared energy source 20, which emits infrared energy 21 toward the food holding tray 24.

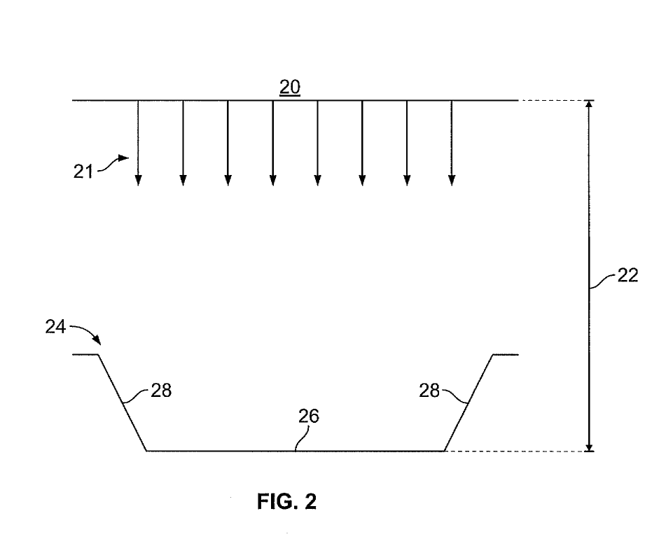

In FIG. 1, the infrared heating source 20 is embodied as one or more heat lamps, well known to those of ordinary skill in the art, but which are also known to widely disperse emitted energy. As depicted by the arrows identified by reference numeral 21, the infrared emitted from the heat lamps does not travel straight down. In order to provide for sufficient heat to foods held in the tray 24, the heating source 20 is located above the bottom 26 of the tray 24 by a predetermined distance, identified by reference numeral 22 and best seen in FIG. 2, which is a partial cross-section of the oven depicted in FIG. 1.

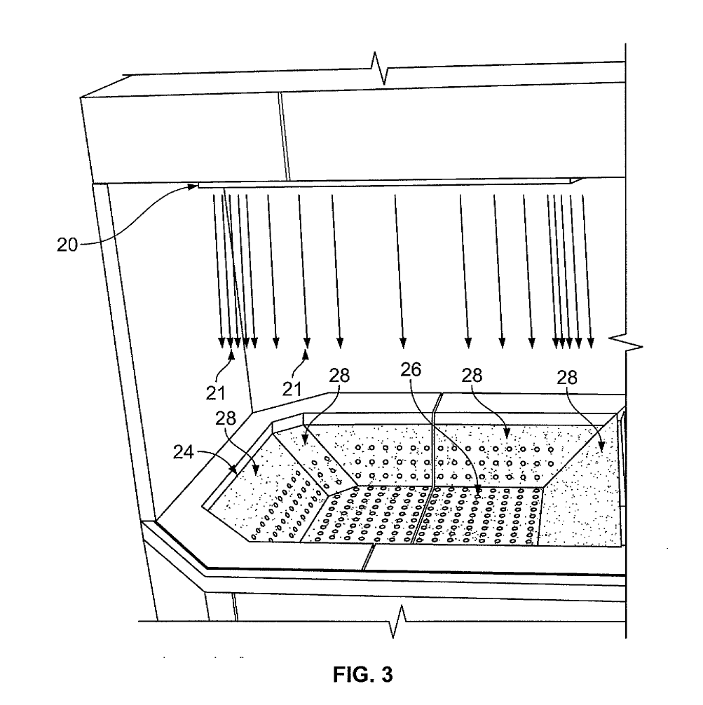

FIG. 3 depicts another embodiment of a food holding oven 10. In FIG. 3, the heat lamps depicted in FIG. 1 are replaced by a planar, infrared heat source, which emits IR albeit more directly downward and with less dispersion than that of the heat lamps. Other than using a different source of IR, the oven depicted in FIG. 3 is identical to the oven depicted in FIG. 1 and FIG. 2.

As can be seen in both FIG. 1 and FIG. 3, the food holding tray 24 is perforated with numerous holes 30. The holes 30 in the tray 24 allow frying oils to drain away from foods that were fried. They also prevent salts from collecting on the bottom 26 and sides 28 of the tray 24,

An important feature of the oven 10 depicted in each of the figures is that the surface of the food holding tray 24 is roughened or “matte.” Experimentation revealed that when the food holding tray 24 with the matte finish was subjected to IR energy for long periods of time, the surface temperature of the matte-finish tray 24 was higher than the surface temperatures of prior art food holding trays having a shiny surface. It is believed that the surface roughness of the matte finish does not reflect IR energy as effectively as does a highly-polished surface used in prior art food holding ovens.

In a preferred embodiment, the matte finish on the stainless steel tray 24 was provided by peening the tray surface using a predetermined shot size. The shot size was selected to provide a resultant surface roughness of approximately 5-40 μm. (micrometers). As used herein, “surface roughness” is considered to be the arithmetic average deviation from the center line of the surface, or as RMS, which is the root mean square of the deviations from the center line.

Surface roughnesses much above about 40 μm tends to damage food product as it is removed the tray and can tend to retain food products, making the tray difficult to clean. Surface roughnesses below about 5 μm will tend to behave as do the prior art shiny surfaces and will not benefit from an increased IR absorption.

A matte finish can also be provided by chemical etching or sand blasting, brushing or otherwise abrasively treating the surface such that it has a surface roughness that diminishes the base material's reflectivity. The increased absorption of IR energy as a result of the matte finish produces a corresponding increase in surface temperature.

In a preferred embodiment, the oven has a maximum input power of about 5000 watts, most of which is output as infrared energy. A preferred embodiment of the oven provides sufficient infrared energy to maintain the tray's surface temperature above about 120 degrees Farenheit but below 180 degrees Farenheit, regardless of how long the IR source has been turned on.

In a food service or restaurant that cooks foods in advance of when they will be served to consumers, the oven 10 can be used to hold previously cooked food at a selected temperature. A method of holding previously cooked food in the oven requires the direction of some amount of infrared energy downwardly into the food holding tray 24 depicted and described herein. The heat energy applied to the food items in the tray 24 can be regulated by modulating the output power or by cycling the IR sources over time. Regardless of how long the IR heat source is left on and regardless of whether the tray 24 is full or empty, its surface temperature will not become so hot that it will burn either the foods kept in the tray 24 or the skin of users who might inadvertently touch the tray when it is in use.

While the preferred embodiment of the tray 24 is stainless steel, which is either mechanically, physically or chemically treated to have a matte finish, an alternate embodiment of the oven 10 uses an aluminum tray, the surfaces of which can be anodized or similarly treated to provide a roughened, matte finish.

Yet another alternate embodiment uses a carbon-fiber composite material the surfaces of which are also roughened to provide a matte finish.

What is claimed is:

1. A food holding oven for holding previously cooked food at a selected temperature, the food holding oven comprising:
a base;
a food holding tray supported by said base, the food holding tray having a surface that is substantially non-reflective in order to elevate the tray's surface temperature through the conversion of infrared energy;
a source of infrared energy located at a predetermined distance above the base and the food holding tray, directing infrared energy toward the food holding tray.

2. The food holding oven of claim 1, wherein the food holding tray has a surface roughness between about 5 and 40 μm.

3. The food holding oven of claim 1, wherein the food holding tray is stainless steel.

4. The food holding oven of claim 1, wherein the food holding tray has a fruso-pyramidal shape, the base of which is open and facing the source of infrared energy, the sides and bottom of which are made from stainless steel.

5. The food holding oven of claim 1, wherein the food holding tray has a fruso-pyramidal shape, the base of which is open and facing the source of infrared energy, the sides and bottom of which are made from stainless steel, perforated to allow air, liquids and granular substances to pass through the perforations.

6. A food holding oven for holding previously cooked food at a selected temperature, the food holding oven comprising:
a base cabinet having a plurality of side panels;
an infrared energy source, attached to and supported by the base cabinet such that the infrared energy source is spaced away from and above the base cabinet by a predetermined distance and directing infrared energy downwardly;
a stainless steel food holding tray having a bottom, four sides, supported by said base cabinet and located below the infrared energy source, the food holding tray having a matte finish on the surfaces of the bottom and sides such that the food holding tray surface temperatures remain substantially below 180 degrees Fahrenheit when the food holding tray is empty and the infrared energy source is emitting infrared energy.

7. The food holding oven of claim 6, wherein the food holding tray has a surface roughness between about 5 and 40 μm.

8. The food holding oven of claim 6, wherein at least one surface of the food holding tray has a matte finish that is provided by peening.

9. The food holding oven of claim 6, wherein at least one surface of the food holding tray has a matte finish that is provided by peening using a predetermined size shot.

10. The food holding oven of claim 6, wherein at least one surface of the food holding tray has a matte finish that is provided by brushing the surface to roughen its surface.

11. The food holding oven of claim 6, wherein at least one surface of the food holding tray has a matte finish that is provided by abrasion, thereby roughening at least one surface.

12. The food holding oven of claim 6, wherein at least one surface of the food holding tray has a matte finish that is provided by chemical etching.

13. The food holding oven of claim 6, wherein the food holding tray is aluminum and at least one surface of the food holding tray has a matte finish that is provided by anodizing.

14. The food holding over of claim 6, wherein the food holding tray has a fruso-pyramidal shape, the base of which is open and facing the source of infrared energy, the sides and bottom of which are made from stainless steel.

15. The food holding over of claim 6, wherein the food holding tray has a fruso-pyramidal shape, the base of which is open and facing the source of infrared energy, the sides and bottom of which are made from stainless steel, perforated to allow air, liquids and granular substances to pass through the perforations.

16. A method of holding previously cooked food at a selected temperature, the method comprising the steps of:
directing a predetermined amount of infrared energy downwardly into a stainless steel food holding tray having the shape of an inverted frusto-pyramid, the base of which is open and facing upwardly toward an infrared energy source, the holding tray having a bottom, four sides, supported by a base cabinet, the bottom and sides having surfaces, the finish of which is roughened, and the surface temperatures of which are kept below about 180 degrees Fahrenheit.

17. The method of claim 16, wherein the food holding tray has a surface roughness between about 5 and 40 μm.

18. A food holding oven for holding previously cooked food at a selected temperature, the food holding oven comprising:
a base;
a food holding tray supported by said base, the food holding tray having a surface that has a surface roughness between 5 and 40 μm; and
a source of infrared energy located at a predetermined distance above the base and the food holding tray, directing infrared energy toward the food holding tray.
